(19) United States
(12) Patent Application Publication
(10) Pub. No.: US 2006/0107014 A1
(43) Pub. Date: May 18, 2006

(54) Managing reclamation for removable data devices

(76) Inventors: Mickey L. Fandrich, Folsom, CA (US); Richard J. Durante, El Dorado Hills, CA (US)

Correspondence Address: TROP PRUNER & HU, PC, 8554 KATY FREEWAY, SUITE 100, HOUSTON, TX, 77024, US

(21) Appl. No.: 10/991,901

(22) Filed: Nov. 17, 2004

(51) Int. Cl. G06F 12/00

(52) U.S. Cl. 711/170; 711/115

(57) ABSTRACT

A removable data device may include memory which needs to be reclaimed. Rather than reclaiming the memory which is no longer allocated at one given time when the memory is substantially no longer available for use, writes to file allocation table may be snooped and when memory units are no longer allocated, they can be scheduled for subsequent reclamation. For example, the reclamation may be scheduled to occur at a period when the system is not otherwise occupied. As a result, the reclamation process may be made less visible to the user, providing more seamless operation.

### BACKGROUND

This invention relates generally to removable data devices.

Removable data devices include devices such as memory cards, serial bus keys or disks and flash drives, that may be removably coupled to electronic systems. The removable data devices are memory modules having a semiconductor memory to allow data to be transitioned between different devices by physically removing the removable data device from one system and reinstalling it in another system. Some formats for removable data devices include Compact-Flash, SmartMedia, MultiMemory Card and Memory Stick.

Removable data devices commonly respond to a well established set of commands. Examples of such commands include read and write sector commands which may be similar to those used be hard disk drives. As the data device is used to store data, available memory sectors may be allocated until there are no more available sectors. As the data device is used, some sectors are no longer allocated but still contain dirty or outdated data and therefore are still considered unavailable to store data.

Thus, a reclaim operation is generally necessary to reclaim unallocated sectors that still store data. However, in many such data devices, the reclaim operation only occurs when no sectors are available. A delay results. Namely, the device cannot continue to store new data until the reclamation operation has been completed.

With some removable data devices, the reclamation can be done quickly enough so as not to disturb the user. But in many removable data devices, the reclamation time is considerably longer and, thus, very visible to the user.

Thus, there is a need for better ways to reclaim memory units in removable data devices.

### BRIEF DESCRIPTION OF THE DRAWINGS

FIG. 1 is a schematic depiction of one embodiment of the present invention; and

FIG. 2 is a flow chart for software in accordance with one embodiment of the present invention.

### DETAILED DESCRIPTION

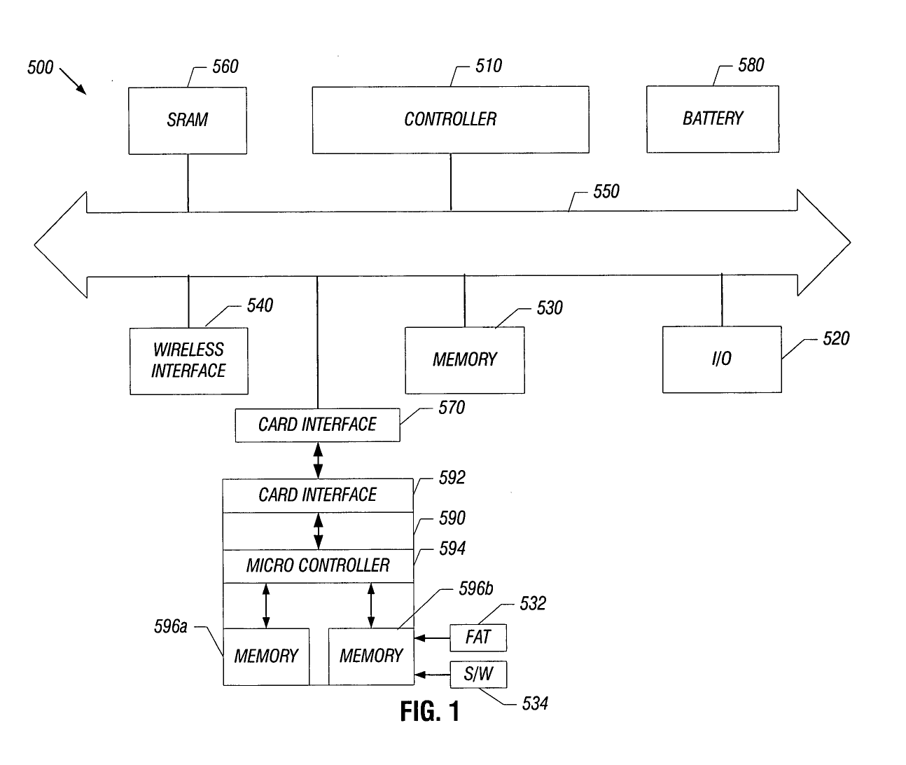

Referring to FIG. 1, a processor-based system 500 may receive a removable data device 590. A removable data device 500 may also receive another removable data device. The processor-based system 500 may, for example, be a laptop computer, a desktop computer, a web tablet, a cellular telephone, a pager, a digital camera, a digital camcorder, a personal digital assistant, a game device, a digital media player, or any other processor-based electronic device. The processor-based system 500 may communicate with the removable data device 590 by a card interface 570 on the processor-based system 500 and a card interface 592 included with the removable data device 590. In one embodiment the device 590 removeably, mechanically and electrically plugs into the system 500.

The removable data device 590 may also include a microcontroller 594. In one embodiment, the microcontroller 594 includes a processor, such as an embedded microcontroller. The microcontroller 594 may communicate with memories 596a and 596b, for example. The memory 596a and 596b may, for example, be flash memories in one embodiment of the present invention. The memory 556b may store a file allocation table (FAT) 532 and a file allocation table management software 534. Files may be stored on the device 590 in random locations. The file allocation table allows each sector of the file to be located by storing a chain of pointers. Each pointer points to the next file sector.

The removable data device microcontroller 594 does not normally have a way to know which data can be reclaimed unless a sector has been rewritten. The card interface 592 does not provide file-level information to the microcontroller 594. The micro-controller 594 only knows that sectors are to be either read or written. Without the file allocation table knowledge, the microcontroller 594 would not know which sectors are no longer in use use due to file deletion. Thus, the knowledge obtained from the file allocation table enables the microcontroller 594 to know which sectors can be reclaimed.

The processor-based system 500 may have any of a variety of architectures including the one depicted at FIG. 1. There, a controller 510 which may be a general purpose microprocessor is coupled to a bus 550. The bus 550 also couples to a wireless interface 540. The interface 540 may allow wireless communications with external devices or external networks. In one embodiment, the wireless interface 540 may be a wireless transceiver that includes a dipole antenna. A static random access memory (SRAM) 560 may also be coupled to the bus 550.

Also coupled to the bus 550 is a memory 530. The memory 530 may be any type of storage device, including a semiconductor memory or a disk-based storage device. Also coupled to the bus 550 is an input/output device 520. The input/output device 520 may, for example, be a display, a keyboard, a microphone, a speech processor, a serial bus interface, or any of a variety of input/output devices.

The file allocation table 532, in one embodiment, may be in accordance with the Microsoft FAT32 File System Specification, Rev. 1.03, Dec. 6, 2000, available from Microsoft Corporation, Redmond, Wash. The specification specifies where the file allocation table is stored on the data device. Thus, the location of the file allocation table may be known to the data device microcontroller 594. The file allocation table 532 holds information that indicates which sectors and groups of sectors, called clusters, are allocated to its particular files. Once the user of the processor-based system 500 deletes a file in a memory 596, the file allocation table 532 is updated to indicate the cluster was de-allocated so that it can subsequently be reclaimed.

In some embodiments of the present invention, the file allocation table 532 may be resident in a memory 596b on the processor-based device 500. In other cases, it may be stored at one of the memory 550, as another example.

In one embodiment, the microcontroller 594 may snoop the writes to the file allocation table 532. In other words, the microcontroller 594 can determine which file allocation table record is being updated and learn which clusters have been de-allocated. The microcontroller 594 can then schedule those clusters to be reclaimed during a time when the data device microcontroller 594 is not so busy. This will prepare memory clusters within the memory 596, for use, ahead of their being needed, thereby mitigating the effect of reclamation on the data device's performance. In other words, only memory program time may be visible to the user in some embodiments.

In the case of writes to a flash memory, a sector that has the capacity to store the data is chosen as the destination for the stored data. The sector, that previously stored the dirty, outdated data that was rewritten to the new sector, is not immediately reused. Instead the revised, updated data is written to a new sector, so that two sectors are now used up even though only one sector has valid data. After awhile the number of available sectors to be written to could be reduced to the point where a sector of sufficient size is not available for a given write operation, because multiple dirty copies of the data may continue to be stored.

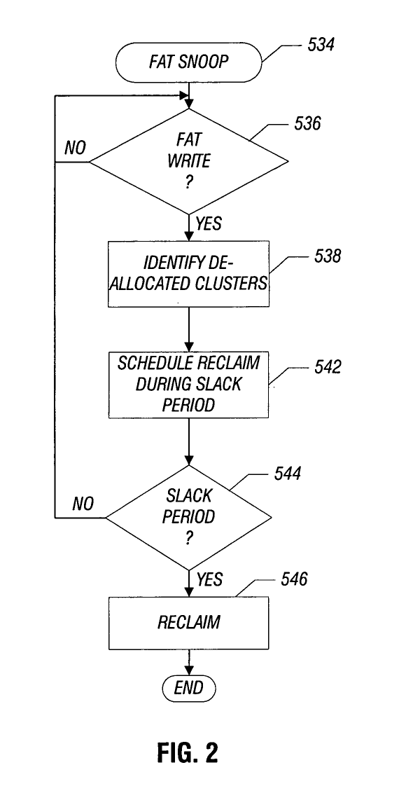

Referring to FIG. 2, the FAT snoop software 534, stored on the memory 596b, begins by determining whether a FAT write has occurred as determined in diamond 536. The file allocation table write may be to mark a sector as being dirty when the data in the sector is updated and rewritten to a new sector. If so, the de-allocated cluster (or other memory unit) may be identified, as indicated in block 538.

A reclamation may be scheduled to occur during the next slack period as determined in block 542. Thus the reclamation may be scheduled as a background process that occurs when no writes are scheduled. In a memory 596 including flash memory the reclamation may be a block erase. Thus, the next time the microcontroller 594 is less active, the reclamation may be scheduled.

As one example, before the device 590 transitions to a lower power consumption state, the reclamation may occur. In other words, the reclamation may be incorporated into the normal power down cycle which occurs in response to the detection of a period of lower activity or in response to a power cycle.

In other embodiments the reclamation occurs when the device 590 is not being used. For example if the device 590 is inactive for a given period of time reclamation may be implemented.

Also the reclamation may be scheduled based on the percentage of available memory sectors to total memory sectors. For example, when the microcontroller 594 has been inactive for a given period of time, where sectors are logged for reclamation and when the percentage is low enough, a reclamation may be scheduled in one embodiment.

In some embodiments a log of sectors to be reclaimed at an opportune time is maintained. Each sector scheduled for reclamation is added to the log. In some embodiments, all of the logged sectors are reclaimed one after another. In other embodiments, sectors are continuously reclalimed until the device 590 becomes more active.

Thus, in one example, a flag may be set when de-allocated clusters are identified in block 538. The next time the device 590 powers down to a lower power consumption state, the flag bit is checked and the reclamation is first initiated before powering down, in response to detection of the previously set flag. However, this embodiment is only one example of ways to implement the reclamation during periods which would not adversely affect the performance of the device 590.

The software 534 next determines if an appropriate slack period has occurred as indicated in diamond 544. According to the example given above, this may correspond to detecting an impending transition to a lower power consumption state. If such a slack period is detected, a reclamation may occur automatically as indicated in block 546. After reclamation, the reclaimed cluster is removed from the reclamation log.

While the present invention has been described with respect to a limited-number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining when a memory unit in a removable data device is de-allocated by snooping a write to a file allocation table; and
scheduling the memory unit for reclamation.

2. The method of claim 1 including snooping a write to a file allocation table and using data about file allocation table write to determine when a memory unit in a removable data device is de-allocated.

3. The method of claim 2 including scheduling the memory unit for subsequent reclamation when no reads or writes are being implemented.

4. The method of claim 3 including reclaiming the memory unit when the device is inactive.

5. The method of claim 1 including reclaiming sectors in a flash memory which contain dirty data during a period when the removable data device is less active.

6. The method of claim 1 including maintaining a log of sectors that have been de-allocated.

7. The method of claim 6 including reclaiming those sectors prior to powering down the removable data device.

8. The method of claim 1 including scheduling a sector for reclamation when the sector is marked as a dirty sector by a write to the file allocation table.

9. An article comprising media storing instructions that, if executed, enable a removable data device to:
determine whether a memory unit in the removable data device is de-allocated by snooping a write to a file allocation table; and
schedule the memory unit for reclamation.

10. The article of claim 9 further storing instructions that, if executed, enable the device to snoop write to a file allocation table and use data about the file allocation table write to determine when a memory unit in the data device is de-allocated.

11. The article of claim 10 further storing instructions that, if executed, enable the device to schedule the memory unit for subsequent reclamation when no reads or writes are being implemented.

12. The article of claim 11 further storing instructions that, if executed, enable the device to reclaim the memory unit when the device is inactive.

13. The article of claim 11 further storing instructions that, if executed, enable the device to reclaim sectors in flash memory that contain dirty data during a period when the device is less active.

14. The article of claim 9 further storing instructions that, if executed, enable the device to maintain a log of sectors that have been de-allocated.

15. The article of claim 14 further storing instructions that, if executed, enable a device to reclaim those de-allocated sectors prior to powering down the removable data device.

16. The article of claim 9 further storing instructions that, if executed, enable the device to schedule a sector for reclamation when the sector is marked as a dirty sector by a write to the file allocation table.

17. A removable data device comprising:
a microcontroller;
a memory coupled to said microcontroller, said memory to store a file allocation table; and
said microcontroller to determine whether a memory unit in said memory is de-allocated by snooping a write to the file allocation table and to schedule the memory unit for reclamation.

18. The device of claim 17 wherein said memory is a flash memory.

19. The device of claim 18 wherein said memory includes two separate integrated circuits.

20. The device of claim 17 wherein said memory stores instructions to snoop a write to a file allocation table and to use data about the file allocation table write to determine when a unit in said memory is de-allocated.

21. The device of claim 20 wherein said memory stores instructions to schedule the memory unit for a subsequent reclamation when no reads and writes are being implemented.

22. The device of claim 17 wherein said memory stores instructions to reclaim a memory unit when the device is inactive.

23. The device of claim 17 wherein said memory stores instructions to reclaim sectors in flash memory that contain dirty data during a period when the device is less active.

24. The device of claim 17 wherein said memory stores instructions to maintain a log of sectors that have been de-allocated.

25. The device of claim 24 wherein said memory stores instructions to reclaim those de-allocated sectors prior to powering down the device.

26. The device of claim 17 wherein said memory stores instructions to schedule a sector for reclamation when the sector is marked as a dirty sector by a write to the file allocation table.

27. A system comprising:
a processor-based device including a processor, a storage coupled to said processor, and an interface; and
a removable data device coupled to said interface, said removable data device including a microcontroller and a memory coupled to said microcontroller, said memory to store a file allocation table, said microcontroller to determine whether a memory unit in said memory is de-allocated by snooping a write to the file allocation table and said microcontroller to schedule the memory unit for reclamation.

28. The system of claim 27 wherein said memory is a flash memory.

29. The system of claim 28 wherein said memory includes two separate integrated circuits.

30. The system of claim 27 wherein said memory stores instructions to snoop a write to a file allocation table and to use data about the file allocation table write to determine when a unit in said memory is de-allocated.

31. The system of claim 30 wherein said memory stores instructions to schedule the memory unit for a subsequent reclamation when no reads and writes are being implemented.

32. The system of claim 27 wherein said memory stores instructions to reclaim a memory unit when the device is inactive.

33. The system of claim 27 wherein said memory stores instructions to reclaim sectors in flash memory that contain dirty data during a period when the device is less active.

34. The system of claim 27 wherein said memory stores instructions to maintain a log of sectors that have been de-allocated.

35. The system of claim 34 wherein said memory stores instructions to reclaim those de-allocated sectors prior to powering down the device.

36. The system of claim 27 wherein said memory stores instructions to schedule a sector for reclamation when the sector is marked as a dirty sector by a write to the file allocation table.
